(19) United States
(12) Patent Application Publication
(10) Pub. No.: US 2025/0326309 A1
(43) Pub. Date: Oct. 23, 2025

(54) APPARATUS AND METHOD FOR CHARGING ELECTRIC VEHICLE

(71) Applicant: LG ELECTRONICS INC., Seoul (KR)

(72) Inventors: Younghoon KIM, Seoul (KR); Junghyun LEE, Seoul (KR); Myoungku LEE, Seoul (KR); Minhyun JUNG, Seoul (KR)

(73) Assignee: LG ELECTRONICS INC., Seoul (KR)

(21) Appl. No.: 18/824,158

(22) Filed: Sep. 4, 2024

(30) Foreign Application Priority Data
Apr. 19, 2024 (WO) PCT/KR2024/005277

(51) Int. Cl. B60L 53/302; B60L 53/30

(52) U.S. Cl. CPC B60L 53/302; B60L 53/305

(57) ABSTRACT

Provided is an apparatus for charging an electric vehicle. The apparatus for charging the electric vehicle includes: a case provided with a vent through which air moves; a cooling fan mounted on at least one side of the case to introduce and discharge air through the vent; a temperature and humidity sensor disposed adjacent to the vent at one side of the case to measure an external temperature and humidity; and a controller configured to receive the external temperature and humidity information, calculate conditions under which condensation occurs in the case on the basis of the external temperature and humidity information, and control an operation of the cooling fan on the basis of the conditions.

### CROSS-REFERENCE TO RELATED APPLICATION

Pursuant to 35 U.S.C. § 119, this application claims the benefit of an earlier filing date and right of priority to International Application No. PCT/KR2024/005277, filed on Apr. 19, 2024, the contents of which are hereby incorporated by reference herein in its entirety.

### BACKGROUND

Embodiments relate to controlling of a cooling fan of an apparatus for charging an electric vehicle.

In general, vehicles have become a representative means of transportation as the vehicles are continuously developed and supplemented, and in recent years, various types of vehicles have appeared, including large luxury vehicles as well as economical compact vehicles.

Recently, the demand for environmentally friendly electric vehicles (EVs) is increasing due to the strengthening of global environmental regulations and the trend of reducing energy costs. In the United States and Europe, the distribution of electric vehicles is becoming mandatory due to the enactment of the Air Conservation Act. Thus, interest in and research on green cars (Eco-friendly vehicles) are being actively conducted in Korea as part of low-carbon green growth.

In addition, as electric vehicles become more popular, apparatuses for charging batteries of electric vehicles are being installed in buildings and public facilities.

In such a charging apparatus according to the related art, when an electric vehicle is changed from a standby state to a charging state, an internal temperature rises rapidly, and thus, a cooling fan for preventing the internal temperature from rising is mounted.

However, since the cooling fan mounted on the charging apparatus is simply driven without considering the temperature and humidity, the lifespan of the cooling fan is shortened, or condensation occurs inside the charging apparatus, and thus, there is a risk of damaging and fire to hardware components due to high current inside the charging apparatus.

### SUMMARY

Embodiments provide an apparatus and method for charging an electric vehicle, which are capable of preventing condensation from occurring inside the charging apparatus.

Embodiments also provide an apparatus and method for charging an electric vehicle, which are capable of preventing a cooling fan mounted inside the charging apparatus from being shortened.

In one embodiment, an apparatus for charging an electric vehicle includes: a case provided with a vent through which air moves; a cooling fan mounted on at least one side of the case to introduce and discharge air through the vent; a temperature and humidity sensor disposed adjacent to the vent at one side of the case to measure an external temperature and humidity; and a controller configured to receive the external temperature and humidity information, calculate conditions under which condensation occurs in the case on the basis of the external temperature and humidity information, and control an operation of the cooling fan on the basis of the conditions.

The apparatus may further include a storage part in which psychrometric chart information is stored, wherein the controller may include the external temperature and humidity information with the psychrometic chart information to calculate the conditions under which the condensation occurs in the case.

The apparatus may further include a communication part configured to receive charging status information comprising a power-on signal, a charging preparation signal, a charging start signal, and a charging end signal, wherein the controller may be configured to control the cooling fan so that an RPM of the cooling fan is differently set on the basis of the charging status information.

The controller may be configured to: control the cooling fan so as to operate at a first RPM when the power-on signal is received while the external temperature has a temperature value between a first temperature and a second temperature; and determine whether the humidity corresponds to the conditions under which the condensation occurs in the case when the charging preparation signal is received and control the cooling fan so as to operate at a second RPM greater than the first RPM when the humidity is greater than first humidity corresponding to the conditions under which the condensation occurs in the case.

The controller may be configured to control the cooling fan so as to operate at a first RPM when the humidity is less than the first humidity.

The controller may be configured to control the cooling fan so as to operate at a third RPM less than the second RPM when the charging start signal is received.

The controller may be configured to: control the cooling fan so as to operate at a fourth RPM less than the first RPM when the power-on signal is received while the external temperature is less than the first temperature; and control the cooling fan so as to operate at a second RMP greater than the fourth RPM when the charging preparation signal is received.

The controller may be configured to control the cooling fan so as to operate at a fifth RPM less than the second RPM when the charging start signal is received.

The cooling fan may include a first cooling fan configured to introduce the air and a second cooling fan configured to discharge the air, and the temperature and humidity sensor is installed adjacent to the first cooling fan.

In another embodiment, a method for charging an electric vehicle includes: receiving external temperature and humidity information; calculating conditions under which condensation occurs in an apparatus for charging the electric vehicle on the basis of the external temperature and humidity information; and controlling an operation of the cooling fan on the basis of the conditions.

The calculating of the conditions may include comparing the external temperature and humidity information with psychrometic chart information to calculate the conditions under which the condensation occurs in a case.

The method according may further include receiving a power-on signal, a charging preparation signal, a charging start signal, and a charging end signal, wherein the controlling of the operation of the cooling fan may include: controlling the cooling fan to operate at a first RPM when the power-on signal is received while the external temperature has a temperature value between a first temperature and a second temperature; and determining whether the humidity corresponds to the conditions under which the condensation occurs in the case when the charging preparation signal is received and controlling the cooling fan to operate at a second RPM greater than the first RPM when the humidity is greater than first humidity corresponding to the conditions under which the condensation occurs in the case.

The controlling of the operation of the cooling fan may include controlling the cooling fan to operate at the first RPM when the humidity is less than the first humidity.

The controlling of the operation of the cooling fan may include: controlling the cooling fan to operate at a fourth RPM less than the first RPM when the power-on signal is received while the external temperature is less than the first temperature; and controlling the cooling fan to operate at a second RMP greater than the fourth RPM when the charging preparation signal is received.

The controlling of the operation of the cooling fan may include controlling the cooling fan to operate at a fifth RPM less than the second RPM when the charging start signal is received.

The details of one or more embodiments are set forth in the accompanying drawings and the description below. Other features will be apparent from the description and drawings, and from the claims.

### BRIEF DESCRIPTION OF THE DRAWINGS

FIG. 1 is a cross-sectional view illustrating an apparatus for charging an electric vehicle according to an embodiment.

FIG. 2 is a view illustrating a configuration of a controller of the apparatus for charging the electric vehicle according to an embodiment.

FIG. 3 is a graph illustrating a hygroscopic chart of moisture air stored in a storage part according to an embodiment.

FIG. 4 is a flowchart illustrating a process of operating a cooling fan on the basis of charging status information according to an embodiment.

FIG. 5 is a flowchart illustrating a process of operating the cooling fan on the basis of external temperature and humidity information according to an embodiment.

FIGS. 6 to 9 are flowcharts illustrating a method for charging an electric vehicle depending on an external temperature value according to an embodiment.

### DETAILED DESCRIPTION OF THE EMBODIMENTS

Hereinafter, embodiments will be described in detail with reference to the accompanying drawings. Since embodiments have diverse modified embodiments, specific embodiments are illustrated in the drawings and are described in the detailed description of the present disclosure. However, this does not limit the present disclosure within specific embodiments and it should be understood that the present disclosure covers all the modifications, equivalents, and replacements within the idea and technical scope of the embodiment.

It will be understood that although the terms “first, and “second” are used herein to describe various elements, these elements should not be limited by these terms. The terms are only used to distinguish one component from other components. Also, the terms specifically defined in consideration of the configuration and operation of the embodiments are only for explaining the embodiments and do not limit the scope of the embodiments.

In the description of the embodiments, when it is described as being formed “above (on or above)” or “below (on or under)” of each element, the above (on or above) or the below (on or under) includes both that two elements are in direct contact with each other, one or more other elements are indirectly formed between the two elements. Also, in the case of being expressed as “above (on or above)” or below (on or under)”, it may include not only an upward direction but also a downward direction with respect to one element.

It is also to be understood that the terms “upper/upper portion/top/” and “lower/lower portion/bottom” as used below are intended to be descriptive and should not be construed as encompassing any physical or logical relationship or order between such entities or elements and also may be used to distinguish one entity or element from another entity or element.

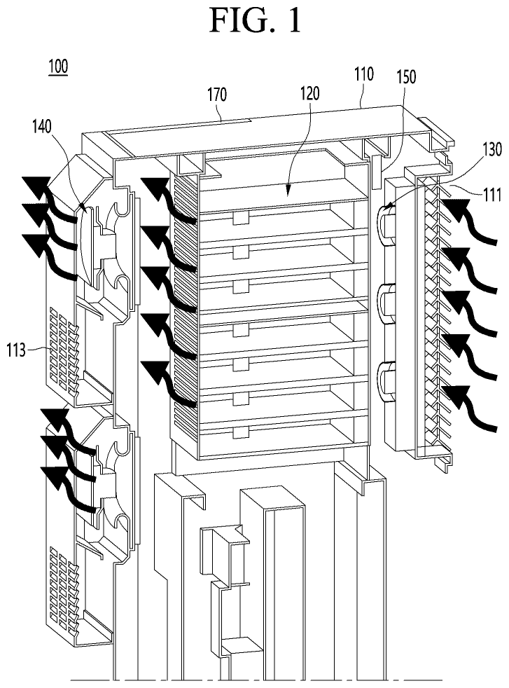

FIG. 1 is a cross-sectional view illustrating an apparatus for charging an electric vehicle according to an embodiment.

Referring to FIG. 1, an apparatus 100 for charging an electric vehicle according to an embodiment may include a case 110, a cooling fan 130, a temperature and humidity sensor 150, and a controller 170.

The case 110 may be provided in a polygonal shape, and a power module 120 capable of charging the electric vehicle may be provided therein. The power module 120 may be connected to a battery of the electric vehicle through a charging nozzle (not shown). The shape of the case 110 is not limited and may be provided in various shapes.

Vents 111 and 113 may be provided in the case 110 to allow external air to pass through the inside thereof. In the vents 111 and 113, a first vent 111 through which air is introduced may be provided at one side of the case 110, and a second vent 113 through which air is discharged may be provided at the other side of the case 110. The second vent 113 may be divided into two vents, but the number of vents 113 is not limited thereto.

The cooling fan 130 may be disposed adjacent to the vents 111 and 113. The cooling fans 130 and 140 may be provided in plurality. The cooling fans 130 and 140 may include a first cooling fan 130 that introduces external air. The first cooling fan 130 may be mounted at one side of the case adjacent to the first vent 111. The cooling fans 130 and 140 may include a second cooling fan 140 that discharges internal air. The second cooling fan 140 may be mounted at the other side of the case adjacent to the second vent 113. The second cooling fan 140 may be divided into two cooling fans, but the number of cooling fans 140 is not limited.

A temperature and humidity sensor 150 may simultaneously measure external temperature and humidity. The temperature and humidity sensor 150 may be installed inside the case 110. The temperature and humidity sensor 150 may be disposed adjacent to the first vent 111 through which the air is introduced. The temperature and humidity sensor 150 may be disposed adjacent to the first vent 111, through which the external air is introduced, to more effectively measure the external temperature and humidity. The mounted position of the temperature and humidity sensor 150 is not limited and may be disposed adjacent to the second vent 113.

The controller 170 may be mounted on an rear inner surface of the case 110. The controller 170 may control an overall operation related to the charging of the electric vehicle.

The controller 170 may control an RPM of each of the cooling fans 130 and 140 to prevent a lifespan of the cooling fans 130 and 140 from being shortened.

The controller 170 may control a speed of each of the cooling fans 130 and 140 to prevent condensation from occurring inside the case 110 during the charging. For example, the controller 170 may calculate conditions under which the condensation occurs in the case 110 on the base of external temperature and humidity information. The controller 170 may control the operations of the cooling fans 130 and 140 on the basis of whether or not to correspond to the calculated conditions.

Although not shown, a payment part and a display device may be provided on a front surface of the case 110. The payment part may accept coins or banknotes or may be configured to allow payment through a radio frequency identification (RFID) card.

The display device may serve to display information such as a residual charging time, an elapsed charging time, or a charging power amount during the charging. The display device may be provided as a touch display to receive an input of an user. The user input may include charging start information, charging-related request information, etc., but the type of pieces of information is not limited.

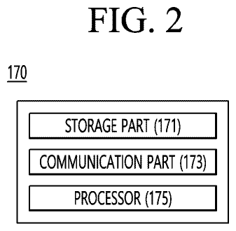

FIG. 2 is a view illustrating a configuration of the controller of the apparatus for charging the electric vehicle according to an embodiment.

Referring to FIG. 2, the controller 170 of the apparatus for charging the electric vehicle according to an embodiment may include a storage part 171, a communication part 173, and a processor 175.

The storage part 171 (memory) may store information related to the charging of the electric vehicle and control programs for performing the charging of the electric vehicle and the control of the cooling fan. The storage part 171 may be main memory accessed and used by the processor 175. For example, the storage part 171 may be a volatile memory such as DRAM. In another embodiment, the storage part 171 may be non-volatile memory, for example, NVDIMM.

The storage part 171 may store the external temperature and humidity measured by the temperature and humidity sensor, a temperature inside the case, temperatures of components inside the charging apparatus, and hygroscopic chart information. Here, hygroscopic chart information may be a graph or information in a graph as a table. The temperature inside the case and the temperatures of the components inside the charging apparatus may be stored as values preset by the user. Alternatively, the temperature inside the case and the temperatures of the components inside the charging apparatus may be obtained by installing a separate thermometer inside the case.

The hygroscopic chart information may be used as an indicator to calculate the conditions under which the condensation occurs within the case using the external temperature and humidity.

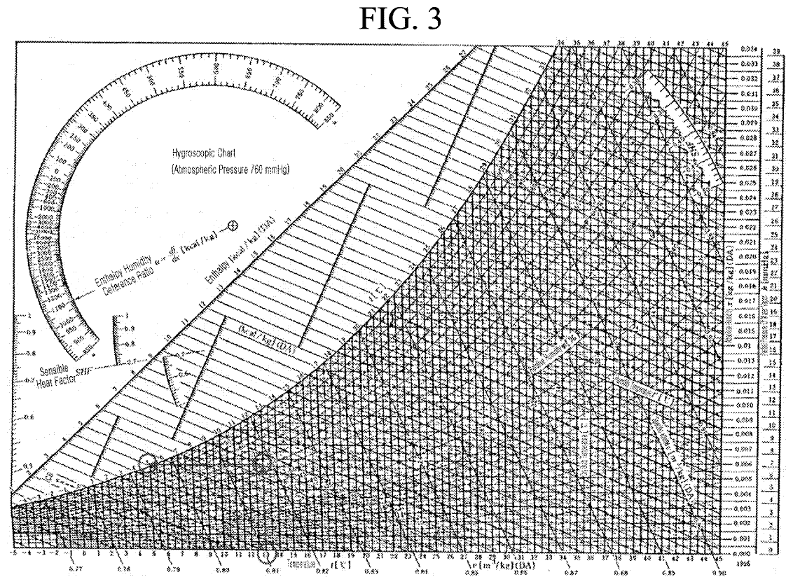

FIG. 3 is a graph illustrating a hygroscopic chart of moisture air stored in the storage part according to an embodiment.

As illustrated in FIG. 3, when matching the hygroscopic chart information under conditions under which the external temperature is about 13° C., and the humidity is about 60%, it is seen that the condensation occurs when an object having a temperature below about 5° C. is touched. That is to say, if there is a difference of about 8° C. between the external temperature and the temperatures of the internal components, the condensation may occur inside the case.

Returning to FIG. 2, the communication part 173 may be a device that includes hardware and software that are necessary for wired or wireless connection with other network devices. The communication part 173 may transmit and receive data signals or control signals related to the charging of the electric vehicle.

The communication part 173 may receive the external temperature and humidity information. The communication part 173 may receive a power-on signal, a charging preparation signal, a charging start signal, and a charging end signal.

The communication part 173 may perform communication using not only LTE and 5G, but also low power wireless network (LPWN) and low power wide area network (LPWAN) such as NB-IoT, LoRa, SigFox, and LTE-CAT1.

The communication part 173 may perform communication using a communication method using a wireless LAN such as WiFi 802.11a/b/g/n as well as a wired local area network (LAN). In addition, the communication part 173 may communicate with internal or external devices using communication methods such as NFC and Bluetooth.

The processor 175 may be a type of central processing unit that is capable of controlling overall operations related to the charging of the electric vehicle and the cooling fan.

The processor 175 may include any type of device capable of processing data. Here, the ‘processor’ may mean, for example, a data processing device that is built into hardware that has a physically structured circuit to perform a function expressed by code or instructions contained in the program. Examples of the data processing devices built into hardware include a microprocessor, a central processing unit (CPU), a processor core, a multiprocessor, and an application-specific integrated circuit (ASIC), a field programmable gate array (FPGA), etc., but is not limited thereto.

Hereinafter, a method for manufacturing an electric vehicle, which is performed by a processor of the controller will be described in detail.

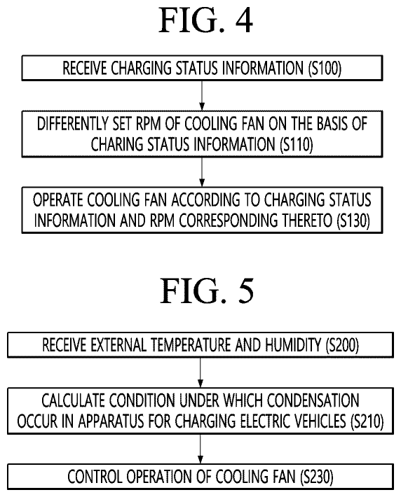

FIG. 4 is a flowchart illustrating a process of operating a cooling fan on the basis of charging status information according to an embodiment.

As illustrated in FIG. 4, a controller may receive charging status information (S100). The charging status information may include a power-on state, a charging preparation state, a charging state, and a charging end state.

The charging status information may be determined from signals sensed by internal components of an apparatus for charging an electric vehicle or signals generated by a user input.

The controller may differently set an RPM of a cooling fan on the basis of the charging status information (S110). The RPM of the cooling fan may be set by adjusting a duty ratio of current supplied to the cooling fan.

When a power-on signal is received, and power is turned on, the controller may set the RPM of the cooling fan by adjusting the duty ratio to about 10% to about 30%. When a charging start signal is received, and the charging starts, the controller may set the RPM of the cooling fan by adjusting the duty ratio to about 60% to about 100%. Here, an external temperature condition may be a state exceeding about 40° C., a state of about 28° C. to about 40° C. or less, a state of about 12° C. to about 28° C. or less, or a state of about 12° C. or less, and the RPM of the cooling fan may be set to different conditions depending on the external temperature condition.

The controller may operate the cooling fan according to the charging status information and the set RPM (S130).

The controller may operate the cooling fan at a preset RPM for a first period of time in the power-on state. The first time may include, for example, about 3 minutes, but the time is not limited thereto. The controller may operate the cooling fan at a preset RPM for a second time in the charging end state. The second time may be, for example, about 10 minutes, but the time is not limited thereto.

FIG. 5 is a flowchart illustrating a process of operating the cooling fan on the basis of external temperature and humidity information according to an embodiment.

As illustrated in FIG. 5, the controller may receive external temperature and humidity information from a temperature and humidity sensor (S200).

The controller may calculate conditions under which condensation occurs within a case of the charging apparatus (S210). The controller may calculate the conditions under which the condensation occurs in the case by matching the external temperature and humidity information to a hygroscopic chart.

The controller may control an operation of the cooling fan on the basis of the conditions under which the condensation occurs inside the case (S230). For example, the controller may control the RPM of the cooling fan so that an RPM of the cooling fan increases if corresponding to the conditions under which the condensation occurs in the state in which the cooling fan operates.

As described above, if increasing in RPM of the cooling fan, the condensation may be prevented from occurring inside the case.

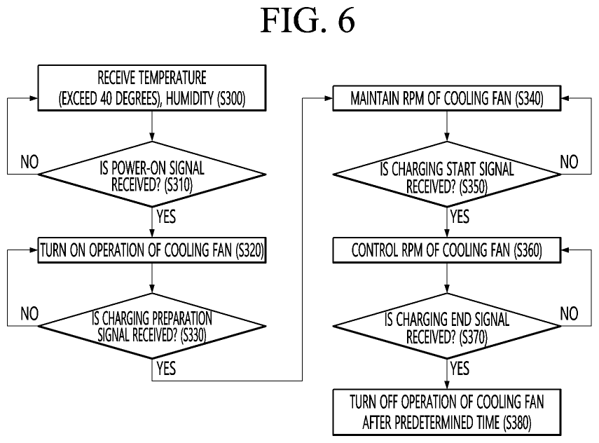

FIGS. 6 to 9 are flowcharts illustrating a method for charging an electric vehicle depending on an external temperature value according to an embodiment.

As illustrated in FIG. 6, the controller may receive the external temperature and humidity from the temperature and humidity sensor (S300). Here, the external temperature may be a temperature exceeding about 40 degrees.

The controller may check whether the power-on signal is received (S310). If the power-on signal is not received, the controller may perform a process of receiving the external temperature and humidity.

The controller may control the cooling fan to turn on when the power-on signal is received, and the power is turned on (S320).

The controller may control the cooling fan to operate at the first RPM by setting the duty ratio of the current supplied to the cooling fan, for example, to about 30%. The controller may drive the cooling fan for a first time, for example, about 5 minutes.

The controller may check whether the charging preparation signal is received (S330).

The controller may control the cooling fan to be maintained at the first RPM when the charging preparation signal is received, and the charging preparation state becomes (S340).

The controller may check whether the charging start signal is received (S350).

When the charging start signal is received, and the charging state is in progress, the controller may control the cooling fan to operate at a second RPM by setting the duty ratio of the current supplied to the cooling fan, for example, to about 1,000% (S360).

The controller may check whether the charging end signal is received (S370).

When the charging end signal is received, and the charging end state becomes, the controller may operate the cooling fan for a second time, for example, about 10 minutes and then turn the cooling fan off (S380).

In the above, the controller may constantly monitor the conditions under which the condensation occurs within the case of the charging apparatus by using humidity information.

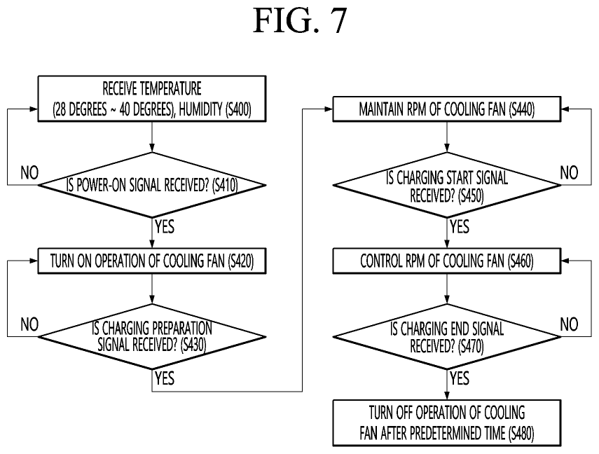

As illustrated in FIG. 7, the controller may receive the external temperature and humidity from the temperature and humidity sensor (S400). Here, the external temperature may be about 20 degrees to about 40 degrees or less.

The controller may check whether the power-on signal is received (S410). If the power-on signal is not received, the controller may perform a process of receiving the external temperature and humidity.

The controller may control the cooling fan to turn on when the power-on signal is received, and the power is turned on (S420).

The controller may control the cooling fan to operate at a third RPM by setting the duty ratio of the current supplied to the cooling fan, for example, to about 20%. The controller may drive the cooling fan for a third time, for example, about 5 minutes.

The controller may check whether the charging preparation signal is received (S430).

The controller may control the cooling fan to be maintained at the third RPM when the charging preparation signal is received, and the charging preparation state becomes (S440).

The controller may check whether the charging start signal is received (S450).

When the charging start signal is received, and the charging state is in progress, the controller may control the cooling fan to operate at a fourth RPM by setting the duty ratio of the current supplied to the cooling fan, for example, to about 800% (S460).

The controller may check whether the charging end signal is received (S470).

When the charging end signal is received, and the charging end state becomes, the controller may operate the cooling fan for a fourth time, for example, about 10 minutes and then turn the cooling fan off (S480).

In the above, the controller may constantly monitor the conditions under which the condensation occurs within the case of the charging apparatus by using humidity information.

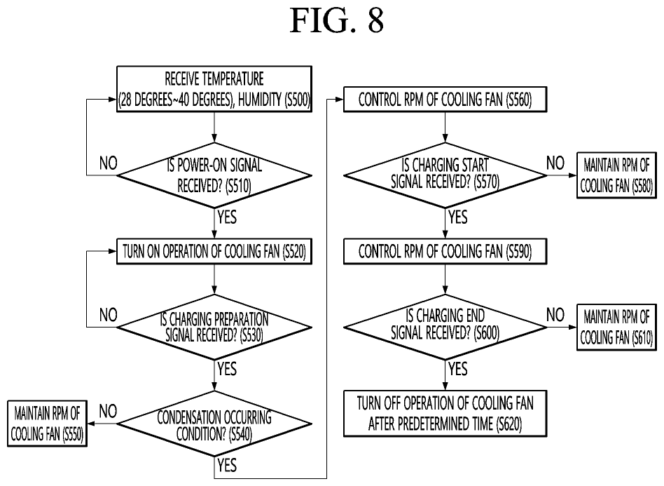

As illustrated in FIG. 8, the controller may receive the external temperature and humidity from the temperature and humidity sensor (S500). Here, the external temperature may be about 12 degrees to about 28 degrees or less.

The controller may check whether the power-on signal is received (S510). If the power-on signal is not received, the controller may perform a process of receiving the external temperature and humidity.

The controller may control the cooling fan to turn on when the power-on signal is received, and the power is turned on (S520).

The controller may control the cooling fan to operate at a fifth RPM by setting the duty ratio of the current supplied to the cooling fan, for example, to about 15%. The controller may drive the cooling fan for a fifth time, for example, about 5 minutes.

The controller may check whether the charging preparation signal is received (S530).

When the charging preparation signal is received, and the charging preparation state becomes, the controller may check whether or not to correspond to the conditions under which the condensation occurring inside the case of the charging apparatus on the basis of the humidity information while the cooling fan is maintained at the fifth RPM (S540).

The controller may control the cooling fan to be maintained at the fifth RPM if the condensation does not occur inside the case of the charging apparatus (S550).

If the condensation occurs inside the case of the charging apparatus, the controller may control the cooling fan to operate at a sixth RPM by setting the duty ratio of the current supplied to the cooling fan, for example, to about 80%. The controller may control the cooling fan to be driven for a fifth time, for example, about 5 minutes (S560).

If the humidity is low, and the condensation does not occur inside the case of the charging apparatus, the controller may control the cooling fan to operate at a seventh RPM by setting the duty ratio of the current supplied to the cooling fan, for example, to about 15%.

The controller may check whether the charging start signal is received (S570).

When the charging start signal is received, and the charging state is in progress, the controller may control the cooling fan to operate at an eighth RPM by setting the duty ratio of the current supplied to the cooling fan, for example, to about 70% (S590).

The controller may check whether the charging end signal is received (S600).

The controller may maintain the cooling fan RPM if the charging end signal is not received (S610).

When the charging end signal is received, and the charging end state becomes, the controller may operate the cooling fan for a sixth time, for example, about 10 minutes and then turn the cooling fan off (S620).

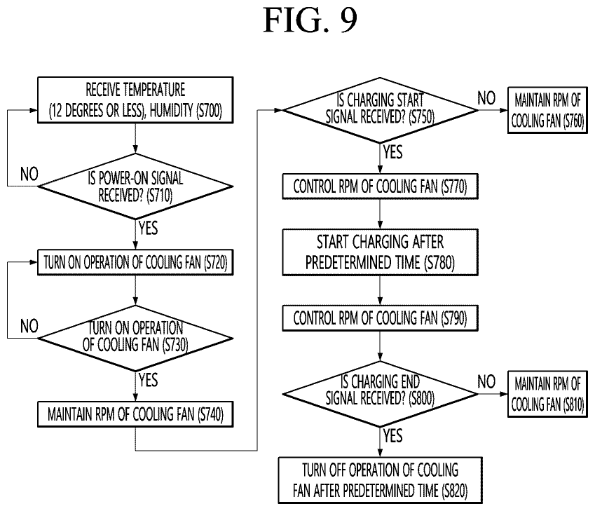

As illustrated in FIG. 9, the controller may receive the external temperature and humidity from the temperature and humidity sensor (S700). Here, the external temperature may be about 12 degrees or less.

The controller may check whether the power-on signal is received (S710). If the power-on signal is not received, the controller may perform a process of receiving the external temperature and humidity.

The controller may control the cooling fan to turn on when the power-on signal is received, and the power is turned on (S720).

The controller may control the cooling fan to operate at a ninth RPM by setting the duty ratio of the current supplied to the cooling fan, for example, to about 10%. The controller may drive the cooling fan for a seventh time, for example, about 5 minutes.

The controller may check whether the charging preparation signal is received (S730).

When the charging preparation signal is received, and the charging preparation state becomes, the controller may control the cooling fan to be maintained at a ninth RPM (S740).

The controller may check whether the charging start signal is received (S750).

When the charging start signal is received, the controller may control the cooling fan to operate at a tenth RPM by setting the duty ratio of the current supplied to the cooling fan, for example, to about 80% before charging the electric vehicle (S770).

The controller may control the charging to start after a certain period of time, for example, about 1 minute (S780).

When being in the charging state, the controller may control the cooling fan to operate at an eleventh RPM by setting the duty ratio of the current supplied to the cooling fan, for example, to about 60% (S790).

The controller may check whether the charging end signal is received (S800).

The controller may maintain the cooling fan RPM if the charging end signal is not received (S810).

When the charging end signal is received, and the charging end state becomes, the controller may operate the cooling fan for an eighth time, for example, about 10 minutes and then turn the cooling fan off (S820).

In the above, the controller may constantly monitor the conditions under which the condensation occurs within the case of the charging apparatus by using humidity information.

According to the embodiments, the RPM of the cooling fan may be controlled in consideration of the external temperature and humidity to prevent the condensation from occurring inside the charging apparatus.

In addition, according to the embodiments, the RPM of the cooling fan may be differently set according to the charging status information to operate, thereby preventing the cooling fan from being damaged.

Hereinabove, although the present disclosure has described with reference to the drawings and the embodiments, it will be apparent to those skilled in the art that various modifications and variations of the present disclosure can be made without departing from the technical ideas as defined by the appended claims.

What is claimed is:

1. An apparatus for charging a battery of an electric vehicle, comprising:
a case provided with a vent through which air moves;
a cooling fan mounted on at least one side of the case, the cooling fan configured to introduce and discharge air through the vent;
a temperature and humidity sensor disposed adjacent to the vent at one side of the case, the temperature and humidity sensor configured to measure an external temperature and humidity; and
a controller configured to:
receive the external temperature and humidity information,
determine conditions under which condensation occurs in the case based on the external temperature and humidity information, and
control an operation of the cooling fan based on the determined conditions.

2. The apparatus according to claim 1, further comprising:
a memory in which psychrometric chart information is stored,
wherein the controller compares the external temperature and humidity information with the psychrometic chart information to determine the conditions under which the condensation occurs.

3. The apparatus according to claim 1, further comprising:
a communication part configured to receive charging status information comprising one of a power-on signal, a charging preparation signal, a charging start signal, or a charging end signal,
wherein the controller is configured to control the cooling fan so that a revolutions per minute (RPM) of the cooling fan is differently set based on the charging status information.

4. The apparatus according to claim 3, wherein the controller is configured to:
control the cooling fan so as to operate at a first RPM when the power-on signal is received while the external temperature has a temperature value between a first temperature and a second temperature;
when the charging preparation signal is received, determine whether the humidity corresponds to the conditions under which the condensation occurs; and
control the cooling fan so as to operate at a second RPM greater than the first RPM when the humidity is greater than a first humidity, the first humidity corresponding to the conditions under which the condensation occurs.

5. The apparatus according to claim 4, wherein the controller is configured to control the cooling fan so as to operate at the first RPM when the humidity is less than the first humidity.

6. The apparatus according to claim 5, wherein the controller is configured to control the cooling fan so as to operate at a third RPM less than the second RPM when the charging start signal is received.

7. The apparatus according to claim 4, wherein the controller is configured to:
control the cooling fan so as to operate at a fourth RPM less than the first RPM when the power-on signal is received while the external temperature is less than the first temperature; and
control the cooling fan so as to operate at a second RMP greater than the fourth RPM when the charging preparation signal is received.

8. The apparatus according to claim 7, wherein the controller is configured to control the cooling fan so as to operate at a fifth RPM less than the second RPM when the charging start signal is received.

9. The apparatus according to claim 1, wherein the cooling fan comprises a first cooling fan configured to introduce the air and a second cooling fan configured to discharge the air, and
the temperature and humidity sensor is installed adjacent to the first cooling fan.

10. A method performed by an apparatus for charging a battery of an electric vehicle, the method comprising:
receiving external temperature and humidity information;
determining conditions under which condensation occurs in the apparatus for charging the electric vehicle based on the external temperature and humidity information; and
controlling an operation of the cooling fan based on the determined conditions.

11. The method according to claim 10, wherein the determining of the conditions comprises comparing the external temperature and humidity information with stored psychrometic chart information.

12. The method according to claim 10, further comprising:
receiving one of a power-on signal, a charging preparation signal, a charging start signal, or a charging end signal,
wherein the controlling of the operation of the cooling fan comprise:
controlling the cooling fan to operate at a first revolutions per minute (RPM) when the power-on signal is received while the external temperature has a temperature value between a first temperature and a second temperature;
when the charging preparation signal is received, determining whether the humidity corresponds to the conditions under which the condensation occurs; and
controlling the cooling fan to operate at a second RPM greater than the first RPM when the humidity is greater than a first humidity, the first humidity corresponding to the conditions under which the condensation occurs.

13. The method according to claim 12, wherein the controlling of the operation of the cooling fan comprises controlling the cooling fan to operate at the first RPM when the humidity is less than the first humidity.

14. The method according to claim 12, wherein the controlling of the operation of the cooling fan comprises:
controlling the cooling fan to operate at a fourth RPM less than the first RPM when the power-on signal is received while the external temperature is less than the first temperature; and
controlling the cooling fan to operate at a second RMP greater than the fourth RPM when the charging preparation signal is received.

15. The method according to claim 14, wherein the controlling of the operation of the cooling fan comprises controlling the cooling fan to operate at a fifth RPM less than the second RPM when the charging start signal is received.
